(19) United States
(12) Patent Application Publication
(10) Pub. No.: US 2018/0231741 A1
(43) Pub. Date: Aug. 16, 2018

(54) OCULAR LENS

(71) Applicant: ZHEJIANG SUNNY OPTICS CO., LTD., Ningbo, Zhejiang (CN)

(72) Inventor: Fujian DAI, Ningbo (CN)

(21) Appl. No.: 15/550,619

(22) PCT Filed: Aug. 15, 2016
(86) PCT No.: PCT/CN2016/095333

§ 371 Date: Aug. 11, 2017

(30) Foreign Application Priority Data
Jul. 14, 2016 (CN) 201610561743.5

(51) Int. Cl. G02B 13/00; G02B 9/62; G02B 9/60

(52) U.S. Cl. CPC G02B 13/0045; G02B 9/60; G02B 9/62

(57) ABSTRACT

An ocular lens includes an optical stop, a first lens having a refractive power, a second lens having a refractive power, a third lens having a refractive power, a fourth lens having a refractive power and a fifth lens having a refractive power disposed coaxially in sequence from an observing side to a display side. The ocular lens satisfies a conditional expression: 0.75≤EL/f≤1.0; 15<|V3−V4|<32; HFOV≥30°. EL denotes an axial distance from the optical stop to an observing-side surface of the first lens, f denotes an effective focal length of the ocular lens, HFOV denotes a half of the largest field angle of the ocular lens, V3 denotes a dispersion coefficient of the third lens, and V4 denotes a dispersion coefficient of the fourth lens.

### PRIORITY INFORMATION

This application claims priority to and benefits of Chinese Patent Application Serial No. 201610561743.5, filed with the State Intellectual Property Office of P. R. China on Jul. 14, 2016, the entire content of which is incorporated herein by reference.

### FIELD

The present disclosure relates to a technology of optical imaging, and more particularly to an ocular lens.

### BACKGROUND

In recent years, virtual reality technology and augmented reality technology go into a high-speed development stage, a corresponding head-mounted display becomes a popular product in a display field. The head-mounted display is required to be compact in structure, light in weight and easy to be mounted to head, in the meanwhile a field angle thereof is required to be as large as possible, such that a feeling of immersion is enhanced. In addition, it is also required to mainly consider quality of imaging and control various kinds of aberrations of an optical imaging system regarding the head-mounted display. As an optical imaging system, an ocular lens is a core of the head-mounted display, so the ocular lens is required to have a larger field angle and higher imaging quality while having a characteristic of miniaturization. However, in the current ocular lens, the field angle is small, or the miniaturization is not benefited, or the imaging quality is affected.

Patent CN101887166B provides an ocular system for a head-mounted display. In the ocular system, a field angle is less than 40 degrees, and a large field angle is difficult to achieve; an optical lens has a relatively large dimension, which is not beneficial to a volume reduction and can't satisfy the requirement of the head-mounted display for a compact structure. It is not easy to achieve the compact structure, a large field angle and high imaging quality at the same time.

### SUMMARY

The present disclosure seeks to solve at least one of the technical problems existing in the related art. For that reason, an ocular lens is provided by the present disclosure.

The ocular lens according to embodiments of the present disclosure includes an optical stop, a first lens having a refractive power, a second lens having a refractive power, a third lens having a refractive power, a fourth lens having a refractive power and a fifth lens having a refractive power disposed coaxially in sequence from an observing side to a display side;

the ocular lens satisfies a conditional expression:

0.75≤EL/f≤1.0;

15<|V3−V4|<32;

HFOV≤30°;

EL denotes an axial distance from the optical stop to an observing-side surface of the first lens, f denotes an effective focal length of the ocular lens, HFOV denotes a half of a largest field angle of the ocular lens, V3 denotes a dispersion coefficient of the third lens, and V4 denotes a dispersion coefficient of the fourth lens.

In some embodiments, the ocular lens satisfies a conditional expression:

|f/f34|≤0.75;

In which, f denotes the effective focal length of the ocular lens, and f34 denotes a combined focal length of the third lens and the fourth lens.

In some embodiments, the ocular lens satisfies a conditional expression:

0<f/f12<1.3;

In which, f denotes the effective focal length of the ocular lens, and f12 denotes a combined focal length of the first lens and the second lens.

In some embodiments, the ocular lens satisfies a conditional expression:

0.35≤(CT3+CT4)/Td≤0.55;

CT3 denotes a center thickness of the third lens, CT4 denotes a center thickness of the fourth lens, and Td denotes an axial distance from the observing-side surface of the first lens to a display-side surface of the fifth lens.

In some embodiments, the first lens has a positive refractive power, the second lens has a negative refractive power, the third lens has a positive refractive power, and the fourth lens has a negative refractive power.

In some embodiments, the ocular lens satisfies a conditional expression:

0.9<f/f1<1.5;

In which, f denotes the effective focal length of the ocular lens, and f1 denotes an effective focal length of the first lens.

In some embodiments, the ocular lens satisfies a conditional expression:

40<V1<60;

V1 denotes a dispersion coefficient of the first lens.

In some embodiments, the ocular lens includes a sixth lens disposed between the fifth lens and the display side, an observing-side surface of the third lens is a convex surface, a display-side surface of the fourth lens is a concave surface, and an observing-side surface of the sixth lens is a convex surface and a display-side surface of the sixth lens is a concave surface.

In some embodiments, the ocular lens satisfies a conditional expression:

0.35≤(CT3+CT4)/Td≤0.55;

CT3 denotes the center thickness of the third lens, CT4 denotes the center thickness of the fourth lens, and Td denotes an axial distance from the observing-side surface of the first lens to the display-side surface of the sixth lens.

In some embodiments, the third lens and the fourth lens are bonding lenses, and made of glass material.

In some embodiments, the ocular lens satisfies a conditional expression:

2.0<V2/V6<3.0;

V2 denotes a dispersion coefficient of the second lens, and V6 denotes a dispersion coefficient of the sixth lens.

The ocular lens according to embodiments of the present disclosure has advantages of miniaturization and a wide angle, thereby effectively correcting aberration in a whole field angle and obtaining a larger relative eye clearance.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and/or other aspects and advantages of embodiments of the present disclosure will become apparent and more readily appreciated from the following descriptions made with reference to the drawings, in which:

FIG. 1 is a schematic view of an ocular lens according to embodiment 1;

FIG. 2 is a MTF resolution curve of the ocular lens according to embodiment 1;

FIG. 3 is a schematic view of an ocular lens according to embodiment 2;

FIG. 4 is a MTF resolution curve of the ocular lens according to embodiment 2;

FIG. 5 is a schematic view of an ocular lens according to embodiment 3;

FIG. 6 is a MTF resolution curve of the ocular lens according to embodiment 3;

FIG. 7 is a schematic view of an ocular lens according to embodiment 4;

FIG. 8 is a MTF resolution curve of the ocular lens according to embodiment 4;

FIG. 9 is a schematic view of an ocular lens according to embodiment 5;

FIG. 10 is a MTF resolution curve of the ocular lens according to embodiment 5;

FIG. 11 is a schematic view of an ocular lens according to embodiment 6;

FIG. 12 is a MTF resolution curve of the ocular lens according to embodiment 6;

FIG. 13 is a schematic view of an ocular lens according to embodiment 7;

FIG. 14 is a MTF resolution curve of the ocular lens according to embodiment 7;

FIG. 15 is a schematic view of an ocular lens according to embodiment 8;

FIG. 16 is a MTF resolution curve of the ocular lens according to embodiment 8;

FIG. 17 is a schematic view of an ocular lens according to embodiment 9;

FIG. 18 is a MTF resolution curve of the ocular lens according to embodiment 9;

FIG. 19 is a schematic view of an ocular lens according to embodiment 10;

FIG. 20 is a MTF resolution curve of the ocular lens according to embodiment 10.

### DETAILED DESCRIPTION

Embodiments of the present disclosure will be described in detail below. Example of the embodiments will be given in the accompanying drawings. The same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure.

In the description of the present disclosure, it should be understood that terms such as “central,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” and “counterclockwise” should be construed to refer to the orientation as then described or as shown in the drawings under discussion. These relative terms are for convenience of description and do not require that the present invention be constructed or operated in a particular orientation. In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present invention, the term “a plurality of” means two or more than two, unless specified otherwise.

In the present invention, unless specified or limited otherwise, the terms “mounted,” “connected,” “coupled” and the like are used broadly, and may be, for example, fixed connections, detachable connections, or integral connections; may also be mechanical, electrical connections, or communicable with each other; may also be direct connections or indirect connections via intervening structures; may also be inner communications of two elements or interacting relationship of two elements, which can be understood by those skilled in the art according to specific situations.

In the present invention, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

Various embodiments and examples are provided in the following description to implement different structures of the present disclosure. In order to simplify the present disclosure, certain elements and settings will be described. However, these elements and settings are only by way of example and are not intended to limit the present disclosure. In addition, reference numerals may be repeated in different examples in the present disclosure. This repeating is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied.

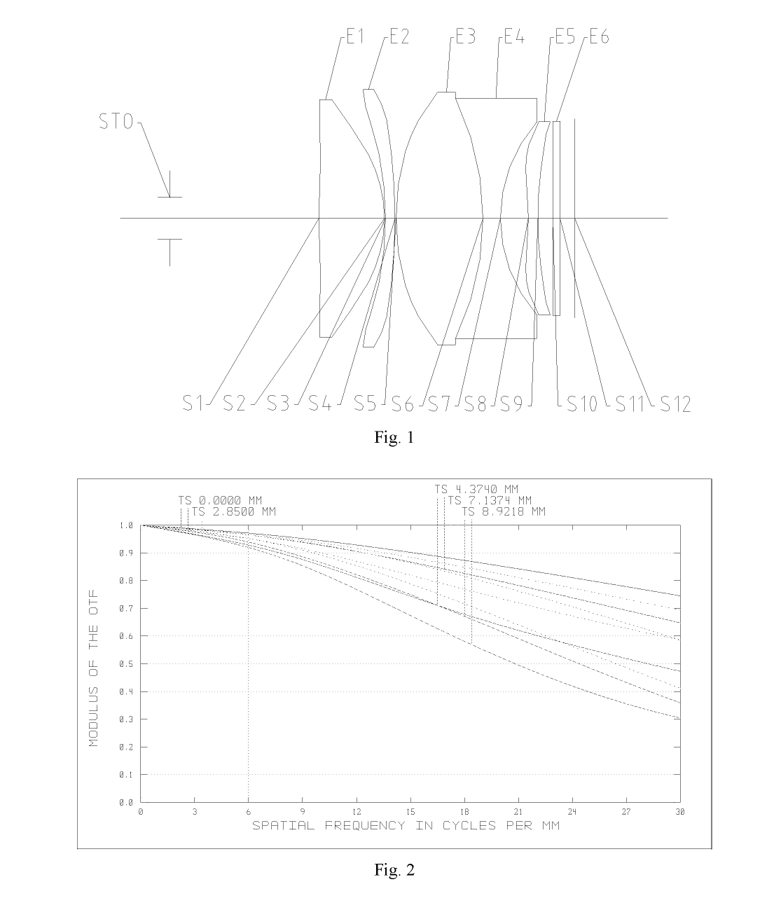

Please refer to FIG. 1, an ocular lens according to embodiments of the present disclosure includes an optical stop STO, a first lens E1 having a refractive power, a second lens E2 having a refractive power, a third lens E3 having a refractive power, a fourth lens E4 having a refractive power and a fifth lens E5 having a refractive power disposed coaxially in sequence from an observing side to a display side.

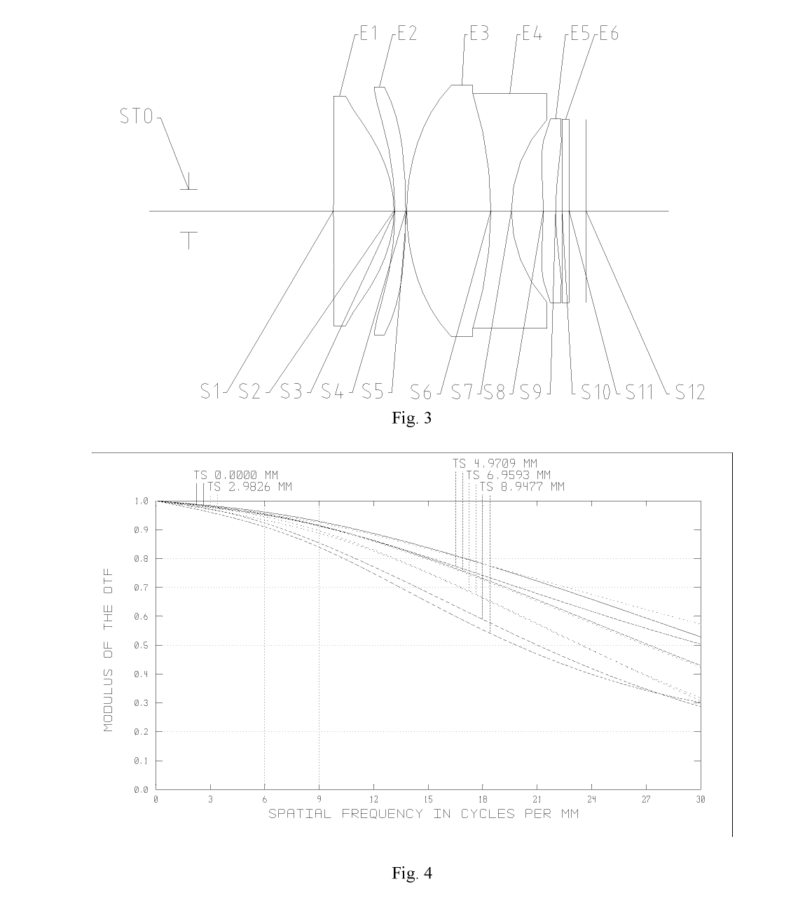

Please refer to FIGS. 3, 5, 7, 9, 11 and 13, in embodiments 1-7 of the present disclosure, the first lens E1 has an observing-side surface S1 and a display-side surface S2, the second lens E2 has an observing-side surface S3 and a display-side surface S4, the third lens E3 has an observing-side surface S5 and a display-side surface S6, the fourth lens E4 has an observing-side surface S6′ and a display-side surface S7, the fifth lens E5 has an observing-side surface S8 and a display-side surface S9. In addition, a protecting glass E6 has an observing-side surface S10 and a display-side surface S11.

During the use, a display device displays an image, rays of the image are emitted from a display surface S12 of the display device, and are projected on human eyes after passing through the ocular lens, so as to be sensed by the human eyes. Therefore, in embodiments of the present disclosure, a side of the ocular lens adjacent to the human eyes is called as the observing side, and another side of the ocular lens adjacent to the display device is called as the display side.

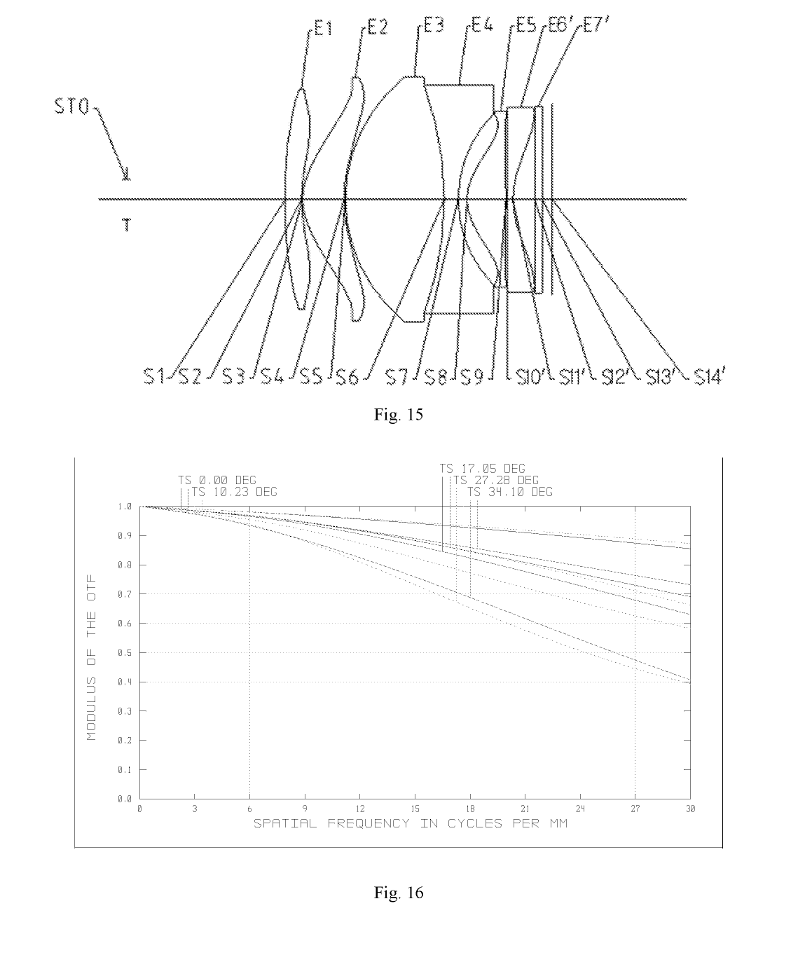

Please refer to FIGS. 15, 17 and 19, in embodiments 8-10 of the present disclosure, the ocular lens further includes a sixth lens E6′ disposed between the fifth lens E5 and the display side. The first lens E1 has the observing-side surface S1 and the display-side surface S2, the second lens E2 has the observing-side surface S3 and the display-side surface S4, the third lens E3 has the observing-side surface S5 and the display-side surface S6, the fourth lens E4 has the observing-side surface S6′ and the display-side surface S7, the fifth lens E5 has the observing-side surface S8 and the display-side surface S9, and the sixth lens E6′ has an observing-side surface S10′ and a display-side surface S11′. In addition, a protecting glass E7′ has an observing-side surface S12′ and a display-side surface S13′.

During the use, the display device displays the image, the rays of the image are emitted from a display surface S14′ of the display device, and are projected on the human eyes after passing through the ocular lens, so as to be sensed by the human eyes. Therefore, in embodiments of the present disclosure, a side of the ocular lens adjacent to the human eyes is called as the observing side, and another side of the ocular lens adjacent to the display device is called as the display side.

In embodiments 1-10, the ocular lens satisfies a conditional expression:

0.75≤EL/f≤1.0;

15<|V3−V4|<32;

HFOV≤30°;

EL denotes an axial distance from the optical stop STO to the observing-side surface S1 of the first lens E1, f denotes an effective focal length of the ocular lens, HFOV denotes a half of a largest field angle of the ocular lens, V3 denotes a dispersion coefficient of the third lens E3, and V4 denotes a dispersion coefficient of the fourth lens E4.

By satisfying the above conditional expression, it is possible to ensure a larger relative eye clearance while achieving a large field angle, and meanwhile, it is beneficial to reduce a chromatic aberration so as to ensure a high definition.

In embodiments 1-10, the ocular lens satisfies a conditional expression:

|f/f34|≤0.75;

In which, f denotes the effective focal length of the ocular lens, and f34 denotes a combined focal length of the third lens E3 and the fourth lens E4.

By satisfying the above conditional expression, it is possible to make the refractive power of the ocular lens to be reasonably distributed, thereby effectively improving the chromatic aberration and enhancing the definition.

In embodiments 1-10, the ocular lens satisfies a conditional expression:

0<f/f12<1.3;

In which, f denotes the effective focal length of the ocular lens, and f12 denotes a combined focal length of the first lens E1 and the second lens E2.

By satisfying the above conditional expression, it is possible to make the refractive power of the ocular lens to be reasonably distributed, thereby effectively enlarging an entrance pupil distance.

In embodiments 1-7, the ocular lens satisfies a conditional expression:

0.35≤(CT3+CT4)/Td≤0.55;

CT3 denotes a center thickness of the third lens E3, CT4 denotes a center thickness of the fourth lens E4, and Td denotes an axial distance from the observing-side surface S1 of the first lens E1 to the display-side surface S9 of the fifth lens E5.

By satisfying the above conditional expression, it is beneficial to reduce a total length of the ocular lens, thereby ensuring a smaller dimension of the ocular lens while giving consideration to the relative eye clearance.

In embodiments 1-7, the first lens E1 has a positive refractive power, the second lens E2 has a negative refractive power, the third lens E3 has a positive refractive power, and the fourth lens E4 has a negative refractive power.

In embodiments 1-7, the ocular lens satisfies a conditional expression:

0.9<f/f1<1.5;

In which, f denotes the effective focal length of the ocular lens, and f1 denotes an effective focal length of the first lens E1.

By satisfying the above conditional expression, it is possible to make the refractive power of the ocular lens to be reasonably distributed, thus improving the resolution power and making each lens an appropriate center thickness in an optical axis meanwhile, so that the dimension of the ocular lens is reduced.

In embodiments 1-7, the ocular lens satisfies a conditional expression:

40<V1<60;

V1 denotes a dispersion coefficient of the first lens E1.

By satisfying the above conditional expression, a dispersion degree is under control, thereby eliminating the chromatic aberration and improving the definition.

In embodiments 8-10, the observing-side surface S5 of the third lens E3 is a convex surface, the display-side surface S7 of the fourth lens E4 is a concave surface, and the observing-side surface S10′ of the sixth lens E6′ is a convex surface and the display-side surface S11′ of the sixth lens E6′ is a concave surface.

In embodiments 8-10, the ocular lens satisfies a conditional expression:

0.35≤(CT3+CT4)/Td≤0.55;

CT3 denotes the center thickness of the third lens E3, CT4 denotes the center thickness of the fourth lens E4, and Td denotes an axial distance from the observing-side surface S1 of the first lens E1 to the display-side surface S11′ of the sixth lens E6′.

By satisfying the above conditional expression, it is beneficial to reduce the total length of the ocular lens, thereby ensuring a smaller dimension of the ocular lens while giving consideration to the relative eye clearance.

In embodiments 8-10, the third lens E3 and the fourth lens E4 are bonding lenses, and made of glass material.

A glass lens has a better imaging effect relative to a plastic lens, and the bonding lens may effectively compensate the chromatic aberration generated by other lenses, thereby maximally reducing the chromatic aberration of a system and improving the definition.

In embodiments 8-10, the ocular lens satisfies a conditional expression:

2.0<V2/V6<3.0;

V2 denotes a dispersion coefficient of the second lens E2, and V6 denotes a dispersion coefficient of the sixth lens E6′.

By satisfying the above conditional expression and making the dispersion coefficients of the second lens E2 and the sixth lens E6′ to be reasonably distributed, it is possible to effectively reduce a lateral chromatic aberration of an outside field of view, thereby achieving a high resolution in a range of a larger field angle.

In embodiments 1-10, the first lens E1, the second lens E2, the third lens E3, the fourth lens E4, the fifth lens E5 and the sixth lens E6′ are all aspheric lenses. A surface shape of the aspheric surface is decided by the following formula:

$$x = \frac{{ch}^{2}}{1 + \sqrt{1 - ( k + 1 ) {c}^{2} {h}^{2}}} + \sum {Aih}^{i}$$

In which, h denotes a height from any point on the aspheric surface to the optical axis, c denotes a curvature of an apex, k denotes a conic constant, and Ai denotes an i-th order correction coefficient of the aspheric surface.

### Embodiment 1

Referring to FIG. 1 to FIG. 2, in embodiment 1, the first lens E1 has the observing-side surface S1 and the display-side surface S2, the second lens E2 has the observing-side surface S3 and the display-side surface S4, the third lens E3 has the observing-side surface S5 and the display-side surface S6, the fourth lens E4 has the observing-side surface S6′ and the display-side surface S7, the fifth lens E5 has the observing-side surface S8 and the display-side surface S9, the protecting glass E6 has the observing-side surface S10 and the display-side surface S11, and the display device has the display surface S12. The third lens E3 and the fourth lens E4 are bonding lenses. Therefore, the display-side surface S6 of the third lens E3 coincides with the observing-side surface S6′ of the fourth lens E4. The ocular lens satisfies conditions shown in the following tables:

TABLE 1

| Surface | | Radius of | Thick- | | Conic Co- |
|---|---|---|---|---|---|
| Number | Surface Type | Curvature | ness | Material | efficient |
| OBJ | Spherical Surface | Infinite | Infinite | | |
| STO | Spherical Surface | Infinite | 14.2000 | | |
| S1 | Aspheric Surface | 55.5429 | 6.2500 | 1.76, 49.3 | −95.4462 |
| S2 | Aspheric Surface | −12.8000 | 0.1000 | | −2.1514 |
| S3 | Aspheric Surface | −29.5329 | 0.9100 | 1.54, 56.1 | −2.8180 |
| S4 | Aspheric Surface | −45.5380 | 0.1000 | | −61.5412 |
| S5 | Aspheric Surface | 25.5186 | 8.2800 | 1.85, 40.6 | 1.0385 |
| S6 | Spherical Surface | −26.5181 | 1.6600 | 1.92, 20.9 | 0 |
| S7 | Spherical Surface | 13.9750 | 2.6695 | | 0 |
| S8 | Aspheric Surface | −24.4451 | 0.9100 | 1.64, 23.5 | −3.0349 |
| S9 | Aspheric Surface | 50.4736 | 1.4132 | | 10.6901 |
| S10 | Spherical Surface | Infinite | 0.7000 | 1.52, 64.2 | |
| S11 | Spherical Surface | Infinite | 1.4000 | | |
| S12 | Spherical Surface | Infinite | | | |

TABLE 2

| Surface | | | | | |
|---|---|---|---|---|---|
| Number | A4 | A6 | A8 | A10 | A12 |
| S1 | −9.5191E−05 | 2.6291E−07 | 5.8617E−09 | −4.0223E−11 | 1.7682E−14 |
| S2 | −1.0596E−04 | −1.6297E−07 | 4.4982E−09 | 2.1566E−11 | −1.4706E−13 |
| S3 | 6.3517E−05 | −1.8173E−06 | 1.3491E−08 | −2.6910E−11 | 1.5201E−14 |
| S4 | −7.6380E−06 | 3.0985E−07 | −3.2893E−09 | −2.8921E−11 | 1.7554E−13 |
| S5 | 2.6477E−05 | 1.3762E−07 | −1.5089E−10 | −2.3913E−12 | −1.0206E−14 |
| S8 | 3.5340E−04 | 2.3348E−06 | −9.0933E−09 | −4.2208E−10 | 2.5545E−12 |
| S9 | 2.2350E−04 | −4.0901E−06 | −1.4797E−08 | 5.3017E−10 | −1.1752E−12 |

### Embodiment 2

Referring to FIG. 3-FIG. 4, in embodiment 2, the first lens E1 has the observing-side surface S1 and the display-side surface S2, the second lens E2 has the observing-side surface S3 and the display-side surface S4, the third lens E3 has the observing-side surface S5 and the display-side surface S6, the fourth lens E4 has the observing-side surface S6′ and the display-side surface S7, the fifth lens E5 has the observing-side surface S8 and the display-side surface S9, the protecting glass E6 has the observing-side surface S10 and the display-side surface S11, and the display device has the display surface S12. The third lens E3 and the fourth lens E4 are bonding lenses. Therefore, the display-side surface S6 of the third lens E3 coincides with the observing-side surface S6′ of the fourth lens E4. The ocular lens satisfies conditions shown in the following tables:

TABLE 3

| | | | | | Conic |
|---|---|---|---|---|---|
| Surface | | Radius of | Thick- | | Co- |
| Number | Surface Type | Curvature | ness | Material | efficient |
| OBJ | Spherical Surface | Infinite | Infinite | | |
| STO | Spherical Surface | Infinite | 14.2000 | | |
| S1 | Aspheric Surface | 95.0858 | 5.9525 | 1.73, 54.0 | 10.3062 |
| S2 | Aspheric Surface | −11.4181 | 0.1045 | | −2.8065 |
| S3 | Aspheric Surface | −26.7017 | 1.0452 | 1.54, 56.1 | −6.4734 |
| S4 | Aspheric Surface | −65.0571 | 0.1039 | | −237.3327 |
| S5 | Aspheric Surface | 22.1773 | 8.2523 | 1.85, 40.1 | 0.1332 |
| S6 | Spherical Surface | −38.0818 | 2.0124 | 1.92, 20.9 | 0 |
| S7 | Spherical Surface | 13.2210 | 3.1435 | | 0 |
| S8 | Aspheric Surface | −38.0191 | 1.2009 | 1.64, 23.5 | 13.2577 |
| S9 | Aspheric Surface | 29.0705 | 0.6309 | | 2.5005 |
| S10 | Spherical Surface | Infinite | 0.7000 | 1.52, 64.2 | |
| S11 | Spherical Surface | Infinite | 1.6500 | | |
| S12 | Spherical Surface | Infinite | | | |

TABLE 4

| Surface | | | | | |
|---|---|---|---|---|---|
| Number | A4 | A6 | A8 | A10 | A12 |
| S1 | −9.7056E−05 | 1.5601E−07 | 5.4646E−09 | −3.8855E−11 | 1.1335E−13 |
| S2 | −8.3236E−05 | −1.5408E−07 | 2.8410E−09 | 8.7172E−12 | 1.1778E−14 |
| S3 | 7.3415E−05 | −1.8426E−06 | 1.3484E−08 | −2.4528E−11 | −1.7377E−14 |
| S4 | −9.6939E−05 | 2.5203E−07 | −2.8491E−10 | −3.5251E−13 | −6.9844E−15 |
| S5 | 1.0924E−05 | 4.5765E−08 | 4.0835E−10 | 8.7171E−13 | −8.8628E−15 |
| S8 | 2.3266E−04 | 1.5204E−06 | 1.4835E−08 | 3.2758E−11 | −3.2711E−12 |
| S9 | −7.2049E−05 | −9.4180E−07 | −1.0298E−08 | 2.8671E−11 | 1.0364E−12 |

### Embodiment 3

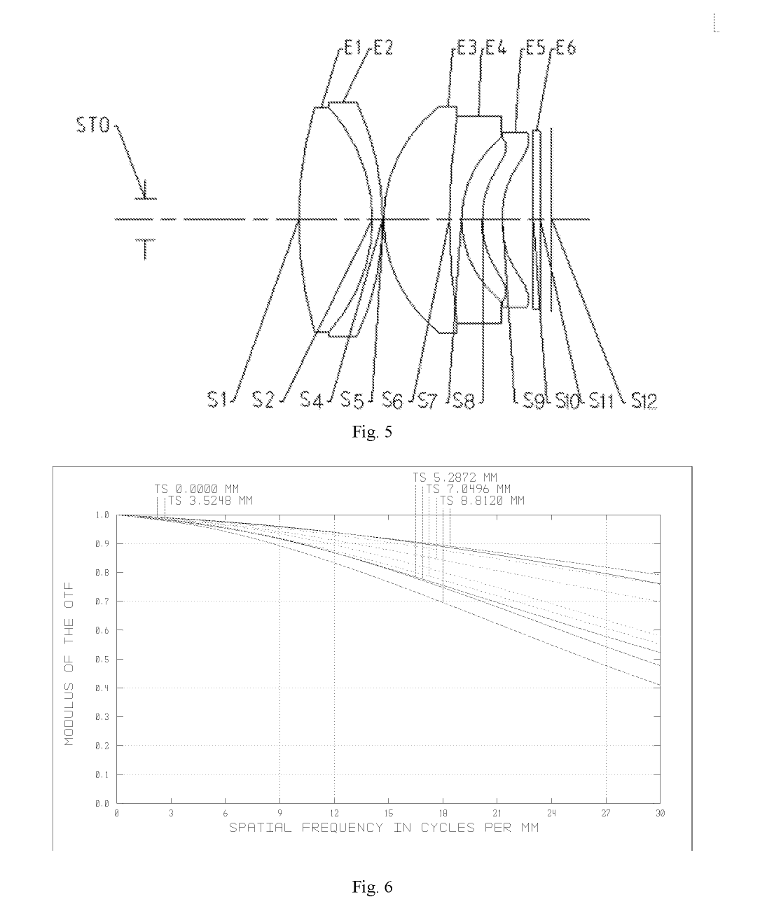

Referring to FIG. 5 to FIG. 6, in embodiment 3, the first lens E1 has the observing-side surface S1 and the display-side surface S2, the second lens E2 has the observing-side surface S3 and the display-side surface S4, the third lens E3 has the observing-side surface S5 and the display-side surface S6, the fourth lens E4 has the observing-side surface S6′ and the display-side surface S7, the fifth lens E5 has the observing-side surface S8 and the display-side surface S9, the protecting glass E6 has the observing-side surface S10 and the display-side surface S11, and the display device has the display surface S12. The first lens E1 and the second lens E2 are bonding lenses, and the third lens E3 and the fourth lens E4 are bonding lenses. Therefore, the display-side surface S2 of the first lens E1 coincides with the observing-side surface S3 of the second lens E2, and the display-side surface S6 of the third lens E3 coincides with the observing-side surface S6′ of the fourth lens E4. The ocular lens satisfies conditions shown in the following tables:

TABLE 5

| | | | | | Conic |
|---|---|---|---|---|---|
| Surface | | Radius of | Thick- | | Co- |
| Number | Surface Type | Curvature | ness | Material | efficient |
| OBJ | Spherical Surface | Infinite | Infinite | | |
| STO | Spherical Surface | Infinite | 15.0000 | | |
| S1 | Spherical Surface | 39.5756 | 7.2152 | 1.77, 49.6 | 0 |
| S2 | Spherical Surface | −16.3746 | 1.0000 | 1.85, 23.8 | 0 |
| S4 | Spherical Surface | −27.3564 | 0.1000 | | 0 |
| S5 | Spherical Surface | 14.0872 | 6.4469 | 1.80, 46.6 | 0 |
| S6 | Spherical Surface | 69.5777 | 1.1729 | 1.85, 23.8 | 0 |
| S7 | Spherical Surface | 10.2552 | 2.0406 | | 0 |
| S8 | Aspheric Surface | 11.1804 | 1.9788 | 1.54, 56.1 | 0.2610 |
| S9 | Aspheric Surface | 18.0466 | 3.0000 | | 1.1498 |
| S10 | Spherical Surface | Infinite | 0.7000 | 1.52, 64.2 | |
| S11 | Spherical Surface | Infinite | 1.1270 | | |
| S12 | Spherical Surface | Infinite | | | |

TABLE 6

| Surface | | | | | | | |
|---|---|---|---|---|---|---|---|
| Number | A4 | A6 | A8 | A10 | A12 | A14 | A16 |
| S8 | 6.6428E−04 | −1.3964E−05 | 6.0914E−08 | −1.3899E−09 | −1.9107E−11 | 2.8224E−15 | 4.0412E−15 |
| S9 | 1.3256E−03 | −1.5341E−05 | −1.1587E−07 | 9.0575E−11 | 1.3665E−11 | 6.6836E−14 | −8.6744E−16 |

### Embodiment 4

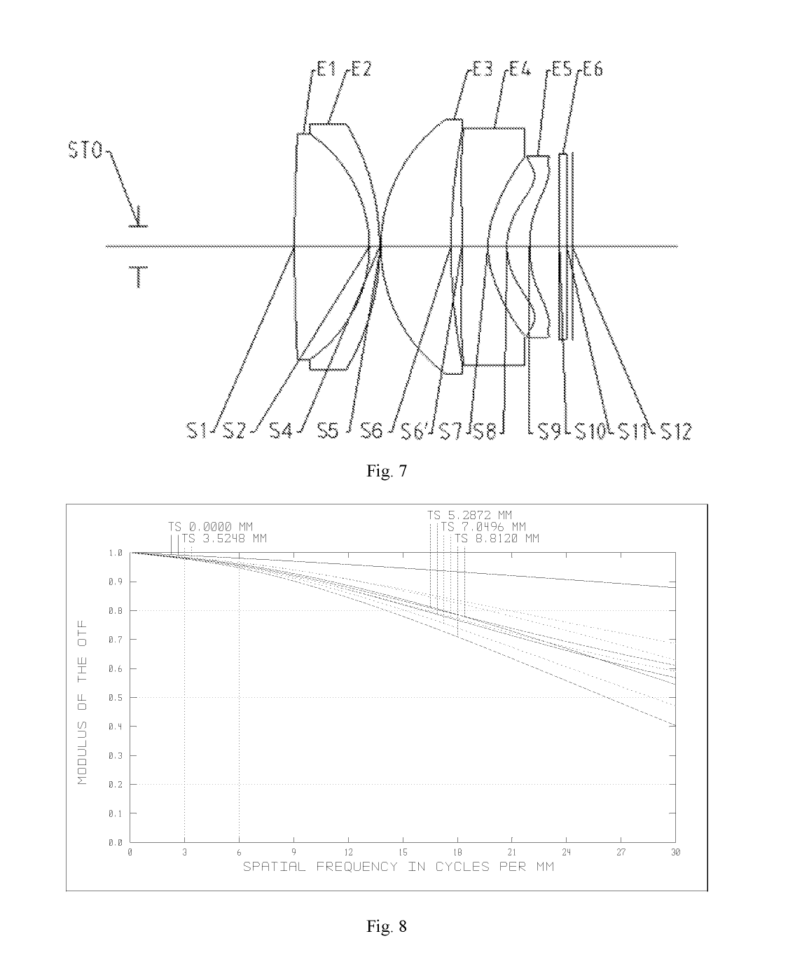

Referring to FIG. 7 to FIG. 8, in embodiment 4, the first lens E1 has the observing-side surface S1 and the display-side surface S2, the second lens E2 has the observing-side surface S3 and the display-side surface S4, the third lens E3 has the observing-side surface S5 and the display-side surface S6, the fourth lens E4 has the observing-side surface S6′ and the display-side surface S7, the fifth lens E5 has the observing-side surface S8 and the display-side surface S9, the protecting glass E6 has the observing-side surface S10 and the display-side surface S11, and the display device has the display surface S12. The first lens E1 and the second lens E2 are bonding lenses. Therefore, the display-side surface S2 of the first lens E1 coincides with the observing-side surface S3 of the second lens E2. The ocular lens satisfies conditions shown in the following tables:

TABLE 7

| | | | | | Conic |
|---|---|---|---|---|---|
| Surface | | Radius of | Thick- | | Co- |
| Number | Surface Type | Curvature | ness | Material | efficient |
| OBJ | Spherical Surface | Infinite | Infinite | | |
| STO | Spherical Surface | Infinite | 15.0000 | | |
| S1 | Spherical Surface | 199.2053 | 7.2231 | 1.80, 46.6 | 0 |
| S2 | Spherical Surface | −13.1258 | 1.0000 | 1.81, 25.5 | 0 |
| S4 | Spherical Surface | −23.2274 | 0.0999 | | 0 |
| S5 | Spherical Surface | 15.1338 | 6.7475 | 1.76, 52.3 | 0 |
| S6 | Spherical Surface | 59.1906 | 1.0552 | | 0 |
| S6′ | Aspheric Surface | −307.9896 | 2.5159 | 1.65, 21.5 | −96.4351 |
| S7 | Aspheric Surface | 9.1329 | 1.8318 | | −0.0063 |
| S8 | Aspheric Surface | 6.7782 | 2.1696 | 1.54, 56.1 | −0.4710 |
| S9 | Aspheric Surface | 14.0429 | 2.8733 | | −6.8718 |
| S10 | Spherical Surface | Infinite | 0.7000 | 1.52, 64.2 | |
| S11 | Spherical Surface | Infinite | 0.5260 | | |
| S12 | Spherical Surface | Infinite | | | |

TABLE 8

| Surface | | | | | | | |
|---|---|---|---|---|---|---|---|
| Number | A4 | A6 | A8 | A10 | A12 | A14 | A16 |
| S6′ | 1.4283E−04 | −7.3654E−06 | 1.7086E−07 | −2.0452E−09 | 1.3489E−11 | −4.6515E−14 | 6.5635E−17 |
| S7 | 2.5171E−04 | −4.7803E−05 | 1.9005E−06 | −4.8730E−08 | 7.8960E−10 | −7.1432E−12 | 2.6468E−14 |
| S8 | 5.0629E−04 | −2.3448E−05 | −4.0360E−07 | 2.7419E−08 | −8.0525E−10 | 1.0656E−11 | −5.0325E−14 |
| S9 | 1.0875E−03 | 2.7754E−05 | −4.5739E−06 | 1.7649E−07 | −3.3584E−09 | 3.1690E−11 | −1.1715E−13 |

### Embodiment 5

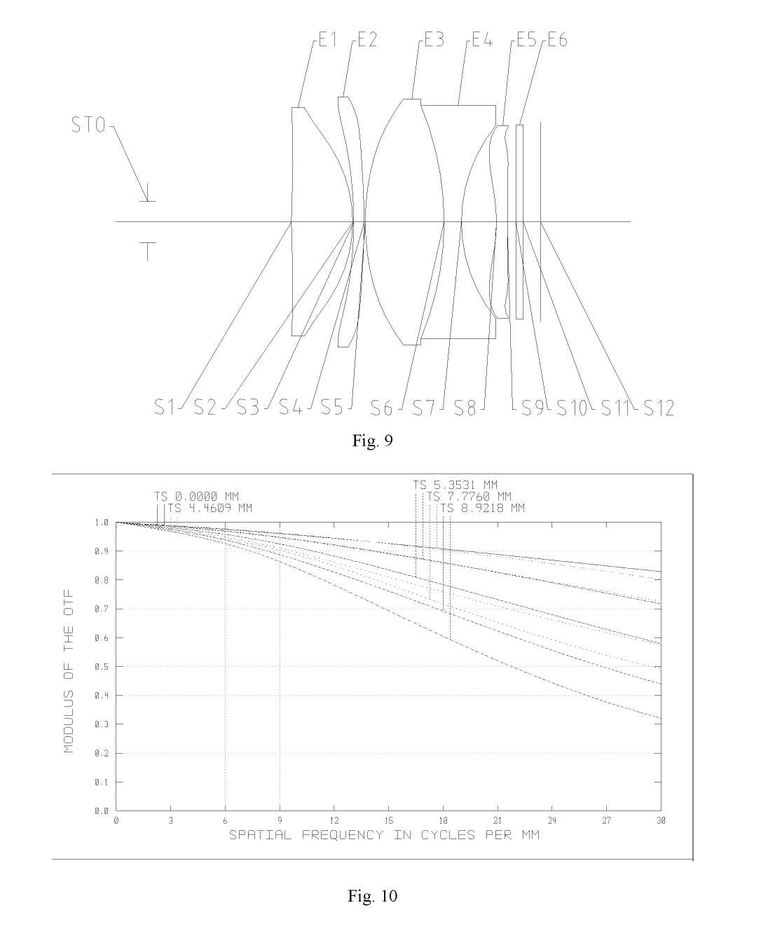

Referring to FIG. 9 to FIG. 10, in embodiment 5, the first lens E1 has the observing-side surface S1 and the display-side surface S2, the second lens E2 has the observing-side surface S3 and the display-side surface S4, the third lens E3 has the observing-side surface S5 and the display-side surface S6, the fourth lens E4 has the observing-side surface S6′ and the display-side surface S7, the fifth lens E5 has the observing-side surface S8 and the display-side surface S9, the protecting glass E6 has the observing-side surface S10 and the display-side surface S11, and the display device has the display surface S12. The third lens E3 and the fourth lens E4 are bonding lenses. Therefore, the display-side surface S6 of the third lens E3 coincides with the observing-side surface S6′ of the fourth lens E4. The ocular lens satisfies conditions shown in the following tables:

TABLE 9

| | | | | | Conic |
|---|---|---|---|---|---|
| Surface | | Radius of | Thick- | | Co- |
| Number | Surface Type | Curvature | ness | Material | efficient |
| OBJ | Spherical Surface | Infinite | Infinite | | |
| STO | Spherical Surface | Infinite | 13.7000 | | |
| S1 | Aspheric Surface | 53.0551 | 5.8500 | 1.76, 49.3 | −99.9900 |
| S2 | Aspheric Surface | −13.3000 | 0.1000 | | −1.8199 |
| S3 | Aspheric Surface | −34.1539 | 1.0000 | 1.54, 56.1 | −4.0557 |
| S4 | Aspheric Surface | −50.1853 | 0.1000 | | −99.9900 |
| S5 | Aspheric Surface | 24.8140 | 7.5000 | 1.85, 40.6 | 0.6700 |
| S6 | Spherical Surface | −29.0500 | 1.6600 | 1.92, 20.9 | 0 |
| S7 | Spherical Surface | 14.6000 | 3.3354 | | 0 |
| S8 | Aspheric Surface | −14.1557 | 1.0300 | 1.64, 23.5 | −1.8900 |
| S9 | Aspheric Surface | Infinite | 0.8253 | | 50.0000 |
| S10 | Spherical Surface | Infinite | 0.7000 | 1.52, 64.2 | |
| S11 | Spherical Surface | Infinite | 1.6500 | | |
| S12 | Spherical Surface | Infinite | | | |

TABLE 10

| Surface | | | | | |
|---|---|---|---|---|---|
| Number | A4 | A6 | A8 | A10 | A12 |
| S1 | −1.0323E−04 | 2.4308E−07 | 6.2307E−09 | −3.6293E−11 | −2.5375E−15 |
| S2 | −1.1460E−04 | −1.7367E−07 | 5.2321E−09 | 3.0648E−11 | −1.7166E−13 |
| S3 | 7.9209E−05 | −1.8299E−06 | 1.3661E−08 | −2.7936E−11 | 1.5405E−14 |
| S4 | 9.6550E−06 | 3.5050E−07 | −3.9655E−09 | −3.8655E−11 | 2.3479E−13 |
| S5 | 2.2316E−05 | 9.2651E−08 | −1.4599E−10 | 2.4678E−12 | −3.1529E−14 |
| S8 | 4.1583E−04 | 4.6264E−06 | −2.0227E−07 | 2.6518E−09 | −1.1068E−11 |
| S9 | −9.2023E−05 | 2.6283E−05 | −1.0081E−06 | 1.2698E−08 | −5.0205E−11 |

### Embodiment 6

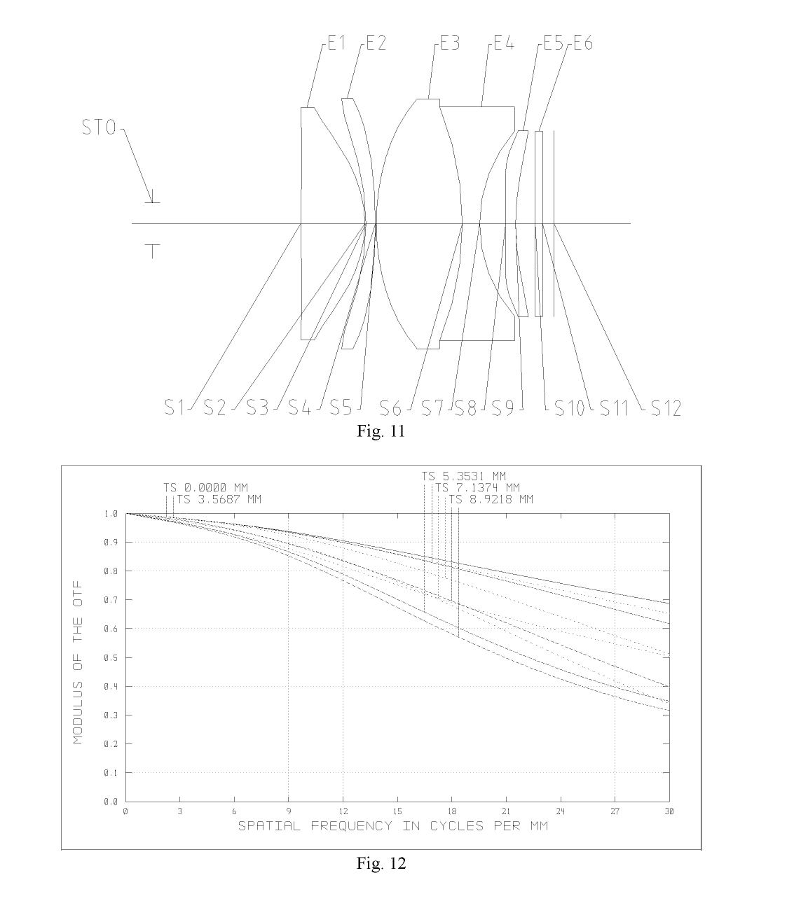

Referring to FIG. 11 to FIG. 12, in embodiment 6, the first lens E1 has the observing-side surface S1 and the display-side surface S2, the second lens E2 has the observing-side surface S3 and the display-side surface S4, the third lens E3 has the observing-side surface S5 and the display-side surface S6, the fourth lens E4 has the observing-side surface S6′ and the display-side surface S7, the fifth lens E5 has the observing-side surface S8 and the display-side surface S9, the protecting glass E6 has the observing-side surface S10 and the display-side surface S11, and the display device has the display surface S12. The third lens E3 and the fourth lens E4 are bonding lenses. Therefore, the display-side surface S6 of the third lens E3 coincides with the observing-side surface S6′ of the fourth lens E4. The ocular lens satisfies conditions shown in the following tables:

TABLE 11

| | | | | | Conic |
|---|---|---|---|---|---|
| Surface | | Radius of | Thick- | | Co- |
| Number | Surface Type | Curvature | ness | Material | efficient |
| OBJ | Spherical Surface | Infinite | Infinite | | |
| STO | Spherical Surface | Infinite | 14.2000 | | |
| S1 | Aspheric Surface | 77.4513 | 6.1545 | 1.77, 49.3 | −32.9845 |
| S2 | Aspheric Surface | −11.0087 | 0.1000 | | −2.6480 |
| S3 | Aspheric Surface | −20.9569 | 0.9000 | 1.54, 56.1 | −4.5603 |
| S4 | Aspheric Surface | −49.0117 | 0.1000 | | −97.0821 |
| S5 | Aspheric Surface | 23.6144 | 8.2398 | 1.85, 40.1 | 0.1897 |
| S6 | Spherical Surface | −30.1258 | 1.6600 | 1.92, 20.9 | 0 |
| S7 | Spherical Surface | 13.5474 | 2.4848 | | 0 |
| S8 | Aspheric Surface | −54.8154 | 0.9507 | 1.64, 23.5 | 18.1891 |
| S9 | Aspheric Surface | 23.9467 | 1.8884 | | 2.9066 |
| S10 | Spherical Surface | Infinite | 0.7000 | 1.52, 64.2 | |
| S11 | Spherical Surface | Infinite | 1.1000 | | |
| S12 | Spherical Surface | Infinite | | | |

TABLE 12

| Surface | | | | | |
|---|---|---|---|---|---|
| Number | A4 | A6 | A8 | A10 | A12 |
| S1 | −9.7099E−05 | 1.5936E−07 | 5.4999E−09 | −3.8793E−11 | 1.0816E−13 |
| S2 | −8.6479E−05 | −1.3274E−07 | 2.9858E−09 | 7.7345E−12 | 2.1848E−14 |
| S3 | 7.2938E−05 | −1.8012E−06 | 1.4004E−08 | −2.2885E−11 | −3.0182E−14 |
| S4 | −8.2033E−05 | 2.6114E−07 | −7.2271E−10 | −3.8795E−12 | 1.7452E−14 |
| S5 | 8.9008E−06 | 6.5000E−08 | 6.6057E−10 | 1.8694E−12 | −2.4737E−14 |
| S8 | 3.5084E−04 | 2.2067E−07 | 2.3542E−09 | 1.3026E−11 | −1.6903E−12 |
| S9 | −1.5526E−05 | −1.2686E−06 | −1.1629E−08 | 7.2107E−11 | 8.6603E−13 |

### Embodiment 7

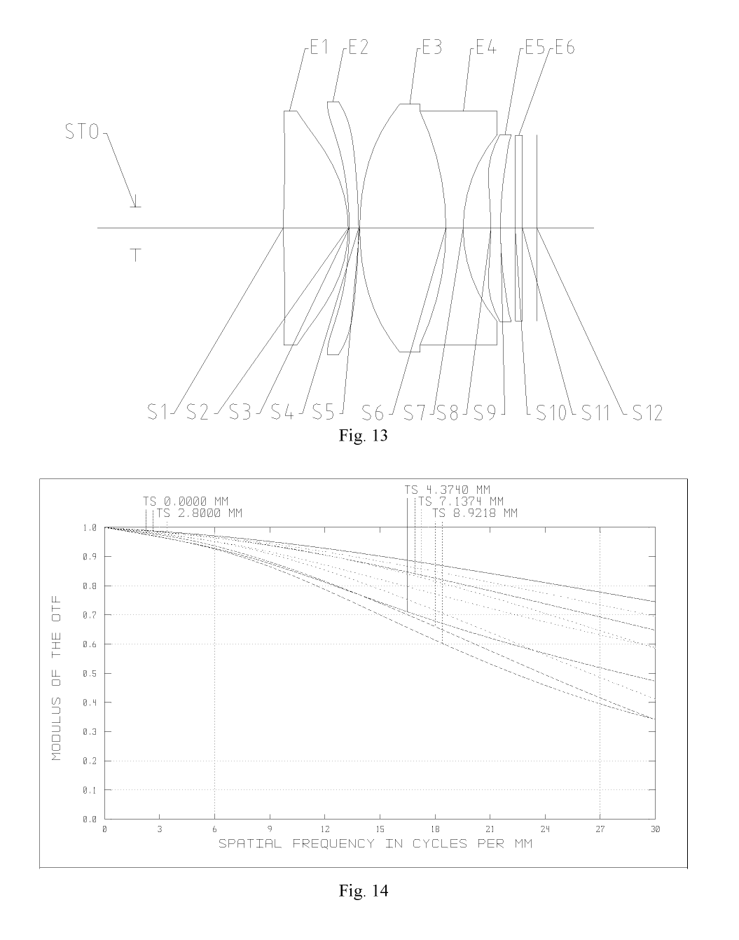

Referring to FIG. 13 to FIG. 14, in embodiment 7, the first lens E1 has the observing-side surface S1 and the display-side surface S2, the second lens E2 has the observing-side surface S3 and the display-side surface S4, the third lens E3 has the observing-side surface S5 and the display-side surface S6, the fourth lens E4 has the observing-side surface S6′ and the display-side surface S7, the fifth lens E5 has the observing-side surface S8 and the display-side surface S9, the protecting glass E6 has the observing-side surface S10 and the display-side surface S11, and the display device has the display surface S12. The third lens E3 and the fourth lens E4 are bonding lenses. Therefore, the display-side surface S6 of the third lens E3 coincides with the observing-side surface S6′ of the fourth lens E4. The ocular lens satisfies conditions shown in the following tables:

TABLE 13

| | | | | | Conic |
|---|---|---|---|---|---|
| Surface | | Radius of | Thick- | | Co- |
| Number | Surface Type | Curvature | ness | Material | efficient |
| OBJ | Spherical Surface | Infinite | Infinite | | |
| STO | Spherical Surface | Infinite | 14.2000 | | |
| S1 | Aspheric Surface | 55.5429 | 6.2500 | 1.76, 49.3 | −95.4462 |
| S2 | Aspheric Surface | −12.8000 | 0.1000 | | −2.1514 |
| S3 | Aspheric Surface | −29.5329 | 0.9100 | 1.54, 56.1 | −2.8180 |
| S4 | Aspheric Surface | −45.5380 | 0.1000 | | −61.5412 |
| S5 | Aspheric Surface | 25.5186 | 8.2800 | 1.85, 40.6 | 1.0385 |
| S6 | Spherical Surface | −26.5181 | 1.6600 | 1.92, 20.9 | 0 |
| S7 | Spherical Surface | 13.9750 | 2.6695 | | 0 |
| S8 | Aspheric Surface | −24.4451 | 0.9100 | 1.64, 23.5 | −3.0349 |
| S9 | Aspheric Surface | 50.4736 | 1.4132 | | 10.6901 |
| S10 | Spherical Surface | Infinite | 0.7000 | 1.52, 64.2 | |
| S11 | Spherical Surface | Infinite | 1.4000 | | |
| S12 | Spherical Surface | Infinite | | | |

TABLE 14

| Surface | | | | | |
|---|---|---|---|---|---|
| Number | A4 | A6 | A8 | A10 | A12 |
| S1 | −9.5191E−05 | 2.6291E−07 | 5.8617E−09 | −4.0223E−11 | 1.7682E−14 |
| S2 | −1.0596E−04 | −1.6297E−07 | 4.4982E−09 | 2.1566E−11 | −1.4706E−13 |
| S3 | 6.3517E−05 | −1.8173E−06 | 1.3491E−08 | −2.6910E−11 | 1.5201E−14 |
| S4 | −7.6380E−06 | 3.0985E−07 | −3.2893E−09 | −2.8921E−11 | 1.7554E−13 |
| S5 | 2.6477E−05 | 1.3762E−07 | −1.5089E−10 | −2.3913E−12 | −1.0206E−14 |
| S8 | 3.5340E−04 | 2.3348E−06 | −9.0933E−09 | −4.2208E−10 | 2.5545E−12 |
| S9 | 2.2350E−04 | −4.0901E−06 | −1.4797E−08 | 5.3017E−10 | −1.1752E−12 |

### Embodiment 8

Referring to FIG. 15 to FIG. 16, in embodiment 8, the first lens E1 has the observing-side surface S1 and the display-side surface S2, the second lens E2 has the observing-side surface S3 and the display-side surface S4, the third lens E3 has the observing-side surface S5 and the display-side surface S6, the fourth lens E4 has the observing-side surface S6′ and the display-side surface S7, the fifth lens E5 has the observing-side surface S8 and the display-side surface S9, the sixth lens E6′ has the observing-side surface S10′ and the display-side surface S11′, the protecting glass E7′ has the observing-side surface S12′ and the display-side surface S13′, and the display device has the display surface S14′. The third lens E3 and the fourth lens E4 are bonding lenses. Therefore, the display-side surface S6 of the third lens E3 coincides with the observing-side surface S6′ of the fourth lens E4. The ocular lens satisfies conditions shown in the following tables:

TABLE 15

| | | | | | Conic |
|---|---|---|---|---|---|
| Surface | | Radius of | Thick- | | Co- |
| Number | Surface Type | Curvature | ness | Material | efficient |
| OBJ | Spherical Surface | Infinite | Infinite | | |
| STO | Spherical Surface | Infinite | 15.0000 | | |
| S1 | Aspheric Surface | −811.3168 | 1.5087 | 1.54, 56.1 | 0 |
| S2 | Aspheric Surface | 13.9880 | 0.0984 | | −10.2727 |
| S3 | Aspheric Surface | 6.0984 | 3.9446 | 1.54, 56.1 | −2.7324 |
| S4 | Aspheric Surface | 16.3615 | 0.1003 | | −2.8342 |
| S5 | Spherical Surface | 16.1358 | 9.3393 | 1.82, 46.6 | 0 |
| S6 | Spherical Surface | −34.9774 | 1.3103 | 1.85, 23.8 | 0 |
| S7 | Spherical Surface | 12.6241 | 0.8248 | | 0 |
| S8 | Aspheric Surface | 5.0319 | 3.6835 | 1.54, 56.1 | −2.0384 |
| S9 | Aspheric Surface | −148.2893 | 0.1098 | | 50.2479 |
| S10′ | Aspheric Surface | 188.5409 | 0.5499 | 1.66, 21.5 | 0 |
| S11′ | Aspheric Surface | 8.6679 | 2.0441 | | −0.9184 |
| S12′ | Spherical Surface | Infinite | 0.7000 | 1.52, 64.2 | |
| S13′ | Spherical Surface | Infinite | 0.9869 | | |
| S14′ | Spherical Surface | Infinite | | | |

TABLE 16

| Surface | | | | | |
|---|---|---|---|---|---|
| Number | A4 | A6 | A8 | A10 | A12 |
| S1 | 4.1452E−04 | −7.3538E−06 | 6.8518E−08 | −3.2484E−10 | 6.6085E−13 |
| S2 | −1.5650E−04 | −9.1355E−07 | 7.9872E−09 | 4.5983E−12 | −3.4718E−14 |
| S3 | 2.7069E−05 | −7.1389E−07 | 4.7644E−10 | 8.9035E−14 | −2.9269E−14 |
| S4 | −6.8897E−05 | 1.6469E−07 | −2.5400E−09 | −1.4016E−12 | −1.1627E−14 |
| S8 | 1.2081E−04 | −8.2112E−06 | −2.9035E−09 | −2.9455E−10 | 6.7687E−12 |
| S9 | 2.6749E−06 | 2.7082E−07 | 3.2173E−09 | 4.3959E−11 | 0 |
| S10′ | −2.8227E−05 | 3.1234E−08 | 4.9017E−10 | −9.5711E−15 | 0 |
| S11′ | −5.4639E−04 | 3.3964E−06 | −2.8469E−08 | 7.0233E−11 | 0 |

### Embodiment 9

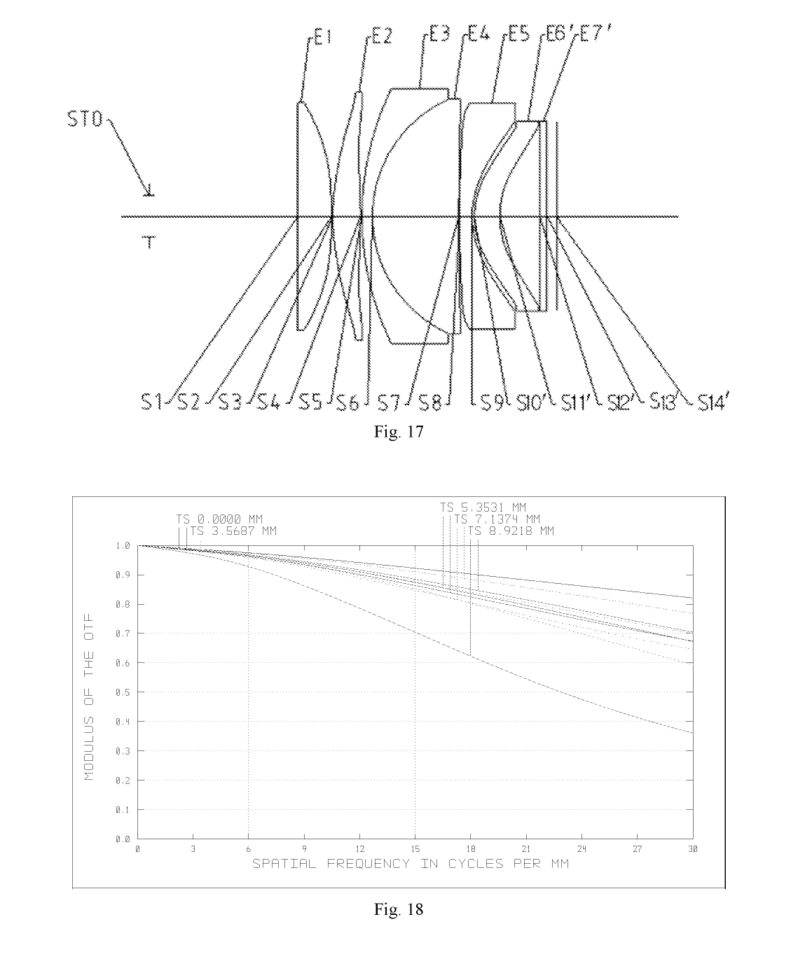

Referring to FIG. 17 to FIG. 18, in embodiment 9, the first lens E1 has the observing-side surface S1 and the display-side surface S2, the second lens E2 has the observing-side surface S3 and the display-side surface S4, the third lens E3 has the observing-side surface S5 and the display-side surface S6, the fourth lens E4 has the observing-side surface S6′ and the display-side surface S7, the fifth lens E5 has the observing-side surface S8 and the display-side surface S9, the sixth lens E6′ has the observing-side surface S10′ and the display-side surface S11′, the protecting glass E7′ has the observing-side surface S12′ and the display-side surface S13′, and the display device has the display surface S14′. The third lens E3 and the fourth lens E4 are bonding lenses. Therefore, the display-side surface S6 of the third lens E3 coincides with the observing-side surface S6′ of the fourth lens E4. The ocular lens satisfies conditions shown in the following tables:

TABLE 17

| | | | | | Conic |
|---|---|---|---|---|---|
| Surface | | Radius of | Thick- | | Co- |
| Number | Surface Type | Curvature | ness | Material | efficient |
| OBJ | Spherical Surface | Infinite | Infinite | | |
| STO | Spherical Surface | Infinite | 14.1030 | | |
| S1 | Aspheric Surface | −470.1866 | 3.2083 | 1.80, 45.4 | 28.9284 |
| S2 | Aspheric Surface | −48.8182 | 0.1000 | | 6.2778 |
| S3 | Aspheric Surface | 19.1669 | 2.6350 | 1.54, 56.1 | −4.0225 |
| S4 | Aspheric Surface | −40.1493 | 0.1000 | | −66.4909 |
| S5 | Spherical Surface | 27.7225 | 1.0004 | 1.92, 20.9 | 0 |
| S6 | Spherical Surface | 12.2395 | 8.1721 | 1.88, 40.8 | 0 |
| S7 | Spherical Surface | 352.0194 | 0.1099 | | 0 |
| S8 | Aspheric Surface | −269.5796 | 1.1348 | 1.64, 23.5 | 50.0000 |
| S9 | Aspheric Surface | 7.5843 | 0.2363 | | −0.3795 |
| S10′ | Aspheric Surface | 7.5705 | 2.4249 | 1.64, 23.5 | −0.5794 |
| S11′ | Aspheric Surface | 11.2094 | 3.7650 | | −2.2398 |
| S12′ | Spherical Surface | Infinite | 0.7000 | 1.52, 64.2 | |
| S13′ | Spherical Surface | Infinite | 0.9000 | | |
| S14′ | Spherical Surface | Infinite | | | |

TABLE 18

| Surface | | | | | | |
|---|---|---|---|---|---|---|
| Number | A4 | A6 | A8 | A10 | A12 | A14 |
| S1 | 1.1002E−04 | −3.3776E−06 | 4.5262E−08 | −2.7337E−10 | 5.9745E−13 | 0 |
| S2 | −1.9280E−04 | 9.9368E−07 | 3.8799E−10 | −1.3268E−11 | 0 | 0 |
| S3 | −2.2943E−04 | 4.2914E−06 | −3.1688E−08 | 7.6797E−11 | 0 | 0 |
| S4 | 1.4183E−04 | −5.0444E−07 | −8.3612E−10 | 1.3919E−12 | 0 | 0 |
| S8 | 3.1251E−04 | −6.5469E−06 | 5.3008E−08 | −1.1503E−10 | 0 | 0 |
| S9 | −6.9099E−04 | 1.0784E−05 | −2.4327E−07 | 3.8126E−09 | −3.7161E−11 | 1.1595E−13 |
| S10′ | 5.8941E−05 | −1.8473E−06 | −4.1476E−07 | 9.3563E−09 | −5.9263E−11 | 0 |
| S11′ | 1.6251E−03 | −4.0074E−05 | 7.9213E−08 | 7.0211E−09 | −7.0326E−11 | 1.4136E−13 |

### Embodiment 10

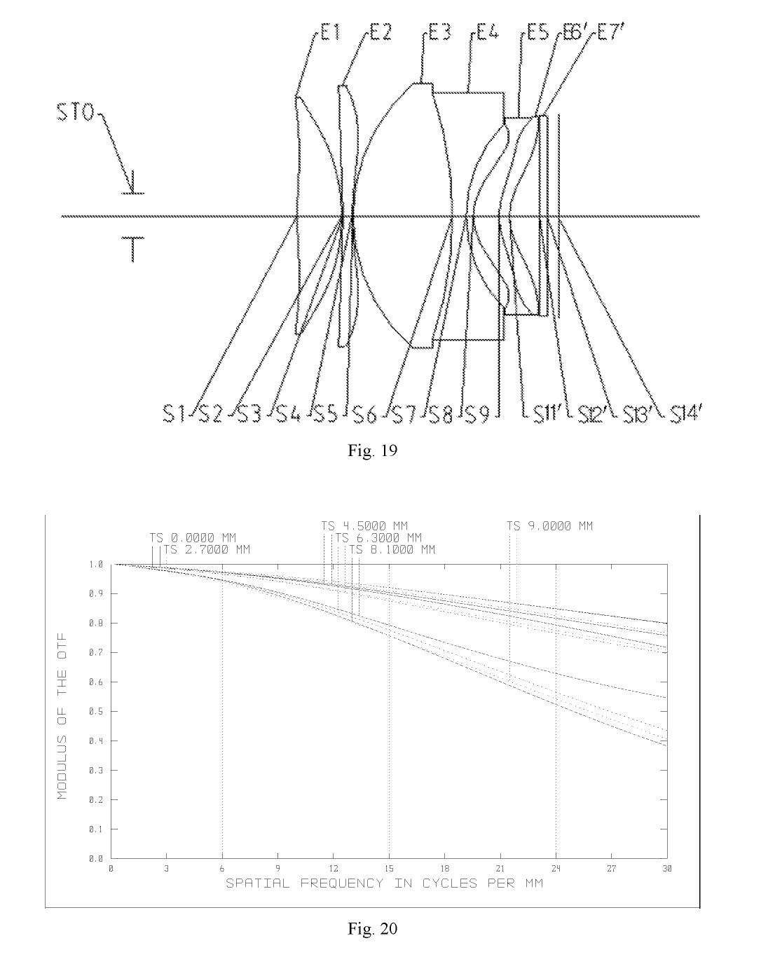

Referring to FIG. 19 to FIG. 20, in embodiment 10, the first lens E1 has the observing-side surface S1 and the display-side surface S2, the second lens E2 has the observing-side surface S3 and the display-side surface S4, the third lens E3 has the observing-side surface S5 and the display-side surface S6, the fourth lens E4 has the observing-side surface S6′ and the display-side surface S7, the fifth lens E5 has the observing-side surface S8 and the display-side surface S9, the sixth lens E6′ has the observing-side surface S10′ and the display-side surface S11′, the protecting glass E7′ has the observing-side surface S12′ and the display-side surface S13′, and the display device has the display surface S14′. The third lens E3 and the fourth lens E4 are bonding lenses, and the fifth lens E5 and the sixth lens E6′ are bonding lenses. Therefore, the display-side surface S6 of the third lens E3 coincides with the observing-side surface S6′ of the fourth lens E4, and the display-side surface S9 of the fifth lens E5 coincides with the observing-side surface S10′ of the sixth lens E6′. The ocular lens satisfies conditions shown in the following tables:

TABLE 19

| | | | | | Conic |
|---|---|---|---|---|---|
| Surface | | Radius of | Thick- | | Co- |
| Number | Surface Type | Curvature | ness | Material | efficient |
| OBJ | Spherical Surface | Infinite | Infinite | | |
| STO | Spherical Surface | Infinite | 14.5985 | | |
| S1 | Aspheric Surface | 29.4006 | 4.0110 | 1.80, 45.4 | −55.3906 |
| S2 | Aspheric Surface | −16.5543 | 0.1000 | | −4.9697 |
| S3 | Aspheric Surface | −77.0423 | 0.7995 | 1.54, 56.1 | −63.4447 |
| S4 | Aspheric Surface | 17.0290 | 0.1000 | | −19.8958 |
| S5 | Spherical Surface | 15.7493 | 8.8672 | 1.92, 20.9 | 0 |
| S6 | Spherical Surface | −34.8975 | 1.2157 | 1.88, 40.8 | 0 |
| S7 | Spherical Surface | 11.7465 | 0.6297 | | 0 |
| S8 | Aspheric Surface | 4.4799 | 2.3010 | 1.64, 23.5 | −1.8993 |
| S9 | Aspheric Surface | 5.6825 | 0.9429 | 1.64, 23.5 | −1.6098 |
| S11′ | Aspheric Surface | 5.1569 | 2.6434 | | −1.2696 |
| S12′ | Spherical Surface | Infinite | 0.7000 | 1.52, 64.2 | |
| S13′ | Spherical Surface | Infinite | 1.0060 | | |
| S14′ | Spherical Surface | Infinite | | | |

TABLE 20

| Surface | | | | | |
|---|---|---|---|---|---|
| Number | A4 | A6 | A8 | A10 | A12 |
| S1 | −1.2027E−04 | −1.7842E−06 | 3.7404E−08 | −2.2842E−10 | 5.3124E−13 |
| S2 | −1.3196E−04 | −3.7477E−07 | 5.7259E−09 | 1.5341E−11 | −3.6432E−14 |
| S3 | 4.7094E−05 | −4.3122E−07 | 1.5860E−09 | 8.4162E−15 | −6.3687E−16 |
| S4 | −1.7287E−04 | 3.9919E−07 | −7.9331E−10 | −8.2672E−14 | −4.9851E−16 |
| S8 | 3.0917E−04 | −1.0292E−05 | −1.1711E−07 | 1.4257E−09 | 1.0179E−13 |
| S9 | −1.7055E−03 | 1.9110E−05 | 4.5485E−08 | −8.9997E−10 | −6.5890E−13 |
| S11′ | −7.5779E−04 | −7.3333E−06 | 1.9600E−07 | −1.0447E−09 | −1.9849E−13 |

In embodiments 1-10, each conditional expression satisfies conditions shown in the following table.

| Conditional | Embodi- | Embodi- | Embodi- | Embodi- | Embodi- | Embodi- | | | | Embodi- |
|---|---|---|---|---|---|---|---|---|---|---|
| Expression | ment 1 | ment 2 | ment 3 | ment 4 | ment 5 | ment 6 | Embodiment 7 | Embodiment 8 | Embodiment 9 | ment 10 |
| EL/f | 0.82 | 0.80 | 0.96 | 0.97 | 0.76 | 0.83 | 0.82 | 0.99 | 0.88 | 0.97 |
| \|V3 − V4\| | 19.7 | 19.2 | 22.8 | 30.8 | 19.7 | 19.2 | 19.7 | 22.8 | 19.9 | 19.9 |
| HFOV | 37.4 | 37.8 | 31.7 | 31.8 | 36.8 | 35.4 | 35.3 | 34.1 | 35.5 | 34.3 |
| \|f/f34\| | 0.42 | 0.33 | 0.08 | 0.59 | 0.38 | 0.37 | 0.42 | 0.04 | 0.45 | 0.00 |
| f/f12 | 1.11 | 1.03 | 0.68 | 0.59 | 1.15 | 1.08 | 1.11 | 0.32 | 0.90 | 0.39 |
| (CT3 + CT4)/ | 0.41 | 0.41 | 0.31 | 0.35 | 0.39 | 0.41 | 0.41 | 0.42 | 0.37 | 0.43 |
| Td | | | | | | | | | | |
| f/f1 | 1.23 | 1.24 | 0.99 | 1.00 | 1.24 | 1.33 | 1.23 | / | / | / |
| V1 | 49.3 | 54.0 | 49.6 | 46.6 | 49.3 | 49.3 | 49.3 | / | / | / |
| V2/V6 | / | / | / | / | / | / | / | 2.61 | 2.38 | 2.61 |

As shown in the above tables and FIGS. 1-20, the refractive power and dispersion coefficient of each lens of the ocular lens according to embodiments of the present disclosure are distributed reasonably, and various aberrations are effectively controlled, thereby it is guaranteed that an ultra-wide field angle is provided, aberrations in the whole field angle are effectively corrected and a larger relative eye clearance is obtained in the premise of keeping a small dimension.

Reference throughout this specification to “an embodiment,” “some embodiments,” “an illustrative embodiment,” “an example,” “a specific example,” or “some examples” means that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that changes, alternatives, variation and modifications can be made to these embodiments without departing from spirit and principles of the present disclosure. The scope of the present disclosure is defined by the claim and its equivalents.

What is claimed is:

1. An ocular lens comprising an optical stop, a first lens having a refractive power, a second lens having a refractive power, a third lens having a refractive power, a fourth lens having a refractive power and a fifth lens having a refractive power disposed coaxially in sequence from an observing side to a display side;
the ocular lens satisfying a conditional expression:
0.75≤EL/f≤1.0;
15<|V3−V4|<32;
HFOV≤30°,
wherein EL denotes an axial distance from the optical stop to an observing-side surface of the first lens, f denotes an effective focal length of the ocular lens, HFOV denotes a half of a largest field angle of the ocular lens, V3 denotes a dispersion coefficient of the third lens, and V4 denotes a dispersion coefficient of the fourth lens.

2. The ocular lens according to claim 1, wherein the ocular lens satisfies a conditional expression: |f/f34|≤0.75,
wherein f denotes the effective focal length of the ocular lens, and f34 denotes a combined focal length of the third lens and the fourth lens.

3. The ocular lens according to claim 1, wherein the ocular lens satisfies a conditional expression: 0<f/f12<1.3,
wherein f denotes the effective focal length of the ocular lens, and f12 denotes a combined focal length of the first lens and the second lens.

4. The ocular lens according to claim 1, wherein the ocular lens satisfies a conditional expression: 0.35≤(CT3+CT4)/Td≤0.55,
wherein CT3 denotes a center thickness of the third lens, CT4 denotes a center thickness of the fourth lens, and Td denotes an axial distance from the observing-side surface of the first lens to a display-side surface of the fifth lens.

5. The ocular lens according to claim 1, wherein the first lens has a positive refractive power, the second lens has a negative refractive power, the third lens has a positive refractive power, and the fourth lens has a negative refractive power.

6. The ocular lens according to claim 5, wherein the ocular lens satisfies a conditional expression: 0.9<f/f1<1.5,
wherein f denotes the effective focal length of the ocular lens, and f1 denotes an effective focal length of the first lens.

7. The ocular lens according to claim 5, wherein the ocular lens satisfies a conditional expression: 40<V1<60,
wherein V1 denotes a dispersion coefficient of the first lens.

8. The ocular lens according to claim 1, wherein the ocular lens comprises a sixth lens disposed between the fifth lens and the display side, an observing-side surface of the third lens is a convex surface, a display-side surface of the fourth lens is a concave surface, and an observing-side surface of the sixth lens is a convex surface and a display-side surface of the sixth lens is a concave surface.

9. The ocular lens according to claim 8, wherein the ocular lens satisfies a conditional expression:
0.35≤(CT3+CT4)/Td≤0.55,
wherein CT3 denotes a center thickness of the third lens, CT4 denotes a center thickness of the fourth lens, Td denotes an axial distance from the observing-side surface of the first lens to the display-side surface of the sixth lens.

10. The ocular lens according to claim 8, wherein the third lens and the fourth lens are bonding lenses, and made of glass material.

11. The ocular lens according to claim 8, wherein the ocular lens satisfies a conditional expression: 2.0<V2/V6<3.0,
wherein V2 denotes a dispersion coefficient of the second lens, and V6 denotes a dispersion coefficient of the sixth lens.
